(19) United States
(12) Patent Application Publication
(10) Pub. No.: US 2020/0212737 A1
(43) Pub. Date: Jul. 2, 2020

(54) ROTOR OF ROTATING ELECTRICAL MACHINE

(71) Applicant: HONDA MOTOR CO., LTD., Tokyo (JP)

(72) Inventor: Masashi INOUE, Saitama (JP)

(73) Assignee: HONDA MOTOR CO., LTD., Tokyo (JP)

(21) Appl. No.: 16/728,932

(22) Filed: Dec. 27, 2019

(30) Foreign Application Priority Data
Dec. 27, 2018 (JP) 2018-245642

(51) Int. Cl. H02K 1/27; H02K 15/03; H02K 21/14

(52) U.S. Cl. CPC H02K 1/276; H02K 21/14; H02K 15/03

(57) ABSTRACT

A rotor of a rotating electrical machine includes a rotor core with a plurality of magnet insertion holes and a plurality of magnetic pole portions including permanent magnets inserted into the plurality of magnet insertion holes. The permanent magnet includes an outer diameter surface and an inner diameter surface, each of which having an arc shape convex radially inward. The magnet insertion hole includes an outer diameter wall surface and an inner diameter wall surface. An outer diameter side space portion is formed at a circumferential central portion in a portion between the outer diameter surface of the permanent magnet and the outer diameter wall surface of the magnet insertion hole, and an inner diameter side space portion is formed at a circumferential central portion in a portion between the inner diameter surface of the permanent magnet and the inner diameter wall surface of the magnet insertion hole.

### CROSS-REFERENCE TO RELATED APPLICATIONS

This application is based on and claims priority under 35 USC 119 from Japanese Patent Application No. 2018-245642 filed on Dec. 27, 2018.

### TECHNICAL FIELD

The present invention relates to a rotor of a rotating electric machine mounted on an electric vehicle or the like.

### BACKGROUND ART

In the related arts, a so-called IPM motor in which a plurality of permanent magnets are arranged at predetermined intervals in a circumferential direction inside a rotor core is known as a rotor used in a rotating electrical machine. A motor using an arc magnet as a permanent magnet, such as a rotor of a rotating electrical machine described in JP-A-2014-100048, is known as such an IPM motor.

In JP-A-2014-100048, a configuration in which, when viewed from the front of the rotor core, a rotor core and a permanent magnet are fixed by abutting both circumferential end surfaces of the arc-shaped permanent magnet on support protrusions provided near both circumferential end portions of a magnet insertion hole is disclosed.

In general, an arc magnet has a larger crossing variation in dimensional accuracy during manufacture than a flat magnet. However, in the rotor of the rotating electrical machine described in JP-A-2014-100048. There is no space between an outer diameter surface of an arc magnet and an outer diameter wall surface of a magnet insertion hole of a rotor core, and between an inner diameter surface of the arc magnet and an inner diameter wall surface of the magnet insertion hole of the rotor core. Therefore, when manufacturing the rotor of the rotating electrical machine, there is a problem that insertability when the arc magnet is inserted into the magnet insertion hole is deteriorated due to the crossing variation in the dimensional accuracy of the arc magnet.

### SUMMARY OF INVENTION

An aspect of the invention provides a rotor of a rotating electrical machine which has excellent insertability when a permanent magnet is inserted into a magnet insertion hole.

An embodiment of the present invention relates to a rotor of a rotating electrical machine, which includes:

a substantially annular rotor core with a plurality of magnet insertion holes formed along a circumferential direction; and

a plurality of magnetic pole portions including permanent magnets inserted into the plurality of magnet insertion holes, wherein

the permanent magnet includes:
an outer diameter surface having an arc shape which is convex radially inward; and
an inner diameter surface having an arc shape convex radially inward and having the same arc center as an arc center of the outer diameter surface,

the magnet insertion hole includes:
an outer diameter wall surface facing the outer diameter surface of the permanent magnet; and
an inner diameter wall surface facing the inner diameter surface of the permanent magnet,

an outer diameter side space portion is formed at a circumferential central portion in a portion between the outer diameter surface of the permanent magnet and the outer diameter wall surface of the magnet insertion hole, and

an inner diameter side space portion is formed at a circumferential central portion in a portion between the inner diameter surface of the permanent magnet and the inner diameter wall surface of the magnet insertion hole.

According to the above embodiment of the invention, the outer diameter side space portion and the inner diameter side space portion are formed at the circumferential central portion in the portion between the permanent magnet and the magnet insertion hole. Thus, insertability when inserting the permanent magnet into the magnet insertion hole is excellent.

### BRIEF DESCRIPTION OF DRAWINGS

FIG. 1 is a front view of a rotor of a rotating electrical machine according to a first embodiment of the invention;

FIG. 2 is an enlarged view around a magnetic pole portion of FIG. 1; and

FIG. 3 is an enlarged view around a magnetic pole portion of a rotor of a rotating electrical machine according to a second embodiment of the invention.

### DESCRIPTION OF EMBODIMENTS

Hereinafter, embodiments of a rotor of a rotating electrical machine according to the invention will be described with reference to the accompanying drawings.

### First Embodiment

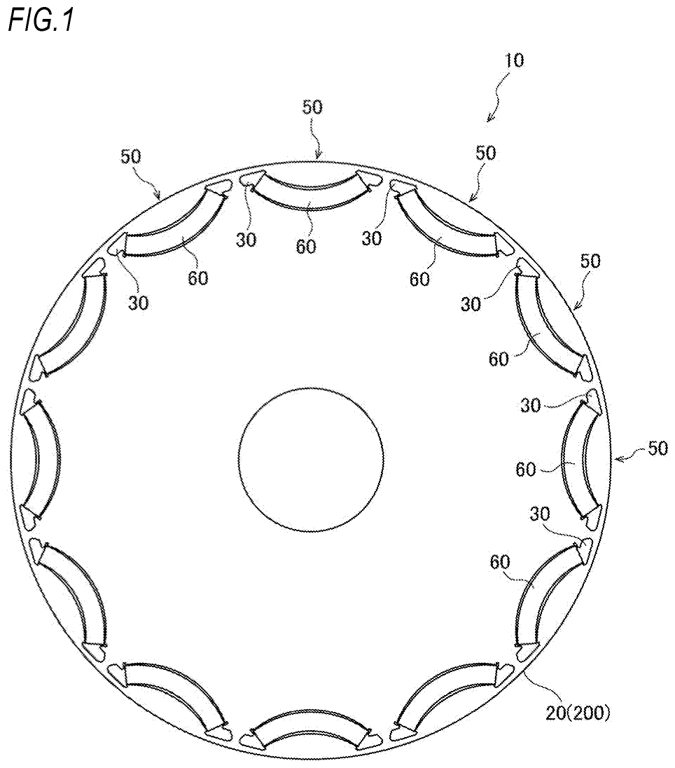

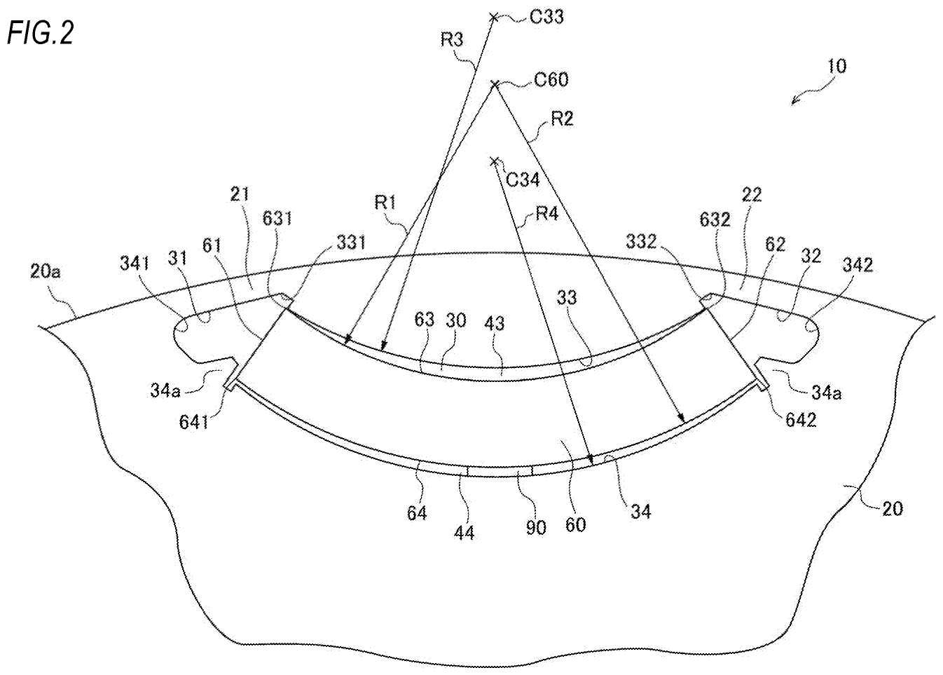

First, a rotor of a rotating electrical machine according to a first embodiment of the invention will be described with reference to FIGS. 1 to 2.

<Overall Configuration of Rotor>

As illustrated in FIG. 1, a rotor 10 of a rotating electrical machine of a first embodiment includes a rotor core 20 attached to an outer peripheral portion of a rotor shaft (not illustrated) and a plurality of magnetic pole portions 50 formed in the rotor core 20 at predetermined intervals in a circumferential direction. The rotor 10 has a substantially annular shape and is disposed on the inner peripheral side of a stator (not illustrated).

The rotor core 20 is formed by laminating a plurality of annular electromagnetic steel plates having substantially the same shape, for example, silicon steel plates 200, in the axial direction, and a plurality of magnet insertion holes 30 are formed at predetermined intervals in the circumferential direction.

The magnetic pole portion 50 is constituted by a permanent magnet 60 inserted into each magnet insertion hole 30. The permanent magnets 60 are magnetized in a radial direction and are arranged so that the magnetization directions of the magnetic pole portions 50 are alternately reversed in the circumferential direction.

<Configuration of Magnetic Pole Portion>

As illustrated in FIG. 2, the permanent magnet 60 has a circular arc shape which is convex radially inward of the rotor core 20. The permanent magnet 60 includes an outer diameter side first end portion 631 and an outer diameter side second end portion 632 which form both end portions in the circumferential direction on the outer diameter side of the rotor core 20 and an inner diameter side first end portion 641 and an inner diameter side second end portion 642 which form both end portions in the circumferential direction on the inner diameter side of the rotor core 20. The permanent magnet 60 includes a first end surface 61 extending from the outer diameter side first end portion 631 to the inner diameter side first end portion 641, a second end surface 62 extending from the outer diameter side second end portion 632 to the inner diameter side second end portion 642, an outer diameter surface 63 extending from the outer diameter side first end portion 631 to the outer diameter side second end portion 632 and having a circular arc shape convex radially inward, and an inner diameter surface 64 extending from the inner diameter side first end portion 641 to the inner diameter side second end portion 642 and having a circular arc shape convex radially inward. In the embodiment, the outer diameter surface 63 and the inner diameter surface 64 respectively have an arc radius R1 and an arc radius R2, and are concentric arcs with the same arc center C60. Therefore, the permanent magnet 60 is an arc magnet having substantially the same thickness in the circumferential direction.

Generally, in a rotor of a rotating electrical machine, both end portions in the circumferential direction of a permanent magnet inserted into a magnet insertion hole are likely to be demagnetized because a short-circuit magnetic flux is generated. The permanent magnet 60 of the embodiment can prevent demagnetization because the thickness at both end portions in the circumferential direction which are likely to be demagnetized is substantially the same as the thickness at the central portion in the circumferential direction.

The magnet insertion hole 30 formed in the rotor core 20 includes an outer diameter side first end portion 331 and an outer diameter side second end portion 332 which form both circumferential end portions on the radially outer side and an inner diameter side first end portion 341 and an inner diameter side second end portion 342 which form both circumferential end portions on the radially inner side. The magnet insertion hole 30 includes a first end wall surface 31 extending from the outer diameter side first end portion 331 to the inner diameter side first end portion 341, a second end wall surface 32 extending from the outer diameter side second end portion 332 to the inner diameter side second end portion 342, an outer diameter wall surface 33 extending from the outer diameter side first end portion 331 to the outer diameter side second end portion 332 and having a circular arc shape convex radially inward, and an inner diameter wall surface 34 extending from the inner diameter side first end portion 341 to the inner diameter side second end portion 342 and having a circular arc shape convex radially inward.

The outer diameter wall surface 33 of the magnet insertion hole 30 has a circular arc shape having an arc radius R3 with an arc center C33. The inner diameter wall surface 34 of the magnet insertion hole 30 has a circular arc shape having an arc radius R4 with an arc center C34. In the inner diameter wall surface 34 of the magnet insertion hole 30, a pair of protrusion portions 34a protruding to the outer diameter side are formed at positions separated from the inner diameter side first end portion 341 and the inner diameter side second end portion 342 by a predetermined length. The permanent magnet 60 is inserted inside the pair of protrusion portions 34a of the magnet insertion hole 30 in the circumferential direction. Thus, even when the permanent magnet 60 moves in the circumferential direction due to the rotation of the rotor 10 or the like, it is possible to restrict the permanent magnet 60 from moving in the circumferential direction by making the first end surface 61 or the second end surface 62 of the permanent magnet abut on the protrusion portion 34a. The outer side in the circumferential direction than the pair of projections 34a of the magnet insertion hole 30 is a gap and functions as a flux barrier.

A first outer peripheral rib 21 is formed between the first end wall surface 31 of the magnet insertion hole 30 and an outer peripheral surface 20a of the rotor core 20. A second outer peripheral rib 22 is formed between the second end wall surface 32 of the magnet insertion hole 30 and the outer peripheral surface 20a of the rotor core 20.

The arc center C33 of the outer diameter wall surface 33 of the magnet insertion hole 30 is located further on the radially outer side of the rotor core 20 than the arc center C60 and the arc radius R3 is larger than the arc radius R1 of the outer diameter surface 63 of the permanent magnet 60, that is, R1<R3. Therefore, the circumferential central portion of the permanent magnet 60 does not abut on the magnet insertion hole 30 and an outer diameter side space portion 43 is formed at the circumferential central portion in a portion between the outer diameter surface 63 of the permanent magnet 60 and the outer diameter wall surface 33 of the magnet insertion hole 30.

The arc center C34 of the inner diameter wall surface 34 of the magnet insertion hole 30 is located further on the radially inner side of the rotor core 20 than the arc center C60 and the arc radius R4 is smaller than the arc radius R2 of the inner diameter surface 64 of the permanent magnet 60, that is, R2>R4. As a result, the circumferential central portion of the permanent magnet 60 does not abut on the magnet insertion hole 30 and an inner diameter side space portion 44 is formed at the circumferential center in a portion between the inner diameter surface 64 of the permanent magnet 60 and the inner diameter wall surface 34 of the magnet insertion hole 30.

Thus, between the outer diameter surface 63 of the permanent magnet 60 and the outer diameter wall surface 33 of the magnet insertion hole 30, the outer diameter side space portion 43 is formed in the central portion in the circumferential direction. Between the inner diameter surface 64 of the permanent magnet 60 and the inner diameter wall surface 34 of the magnet insertion hole 30, the inner diameter side space 44 is formed at the central portion in the circumferential direction. Therefore, when the rotor 10 is manufactured and the permanent magnet 60 is manufactured, even if a crossing variation in dimensional accuracy occurs, the insertability when inserting the arc magnet into the magnet insertion hole is excellent.

By setting R1 and R3 to satisfy R1<R3, the outer diameter side space 43 can be reliably formed with a simple configuration. Similarly, by setting the R2 and R4 to satisfy R2>R4, the inner diameter side space portion 44 can be reliably formed with a simple configuration.

In the inner diameter side space portion 44, a foam sheet 90 is provided at the circumferential central portion of the permanent magnet 60. When manufacturing the rotor 10, the foam sheet 90 is disposed by being attached to the circumferential central portion of the inner diameter surface 64 of the permanent magnet 60 and then inserting the permanent magnet 60 into the magnet insertion hole 30. Then, after inserting the permanent magnet 60 into the magnet insertion hole 30, by foaming the foam sheet 90 by heating or the like, the permanent magnet 60 is pressed radially outward and fixed to the rotor core 20 in a state where the outer diameter side first end portion 631 and the outer diameter side second end portion 632 abut on the outer diameter wall surface 33 of the magnet insertion hole 30.

When the permanent magnet 60 abuts on the circumferential central portion of the outer diameter wall surface 33 of the magnet insertion hole 30, during the rotation of the rotor 10, a centrifugal force generated in the permanent magnet 60 causes a stress in the circumferential central portion of the outer diameter wall surface 33 of the magnet insertion hole 30. When stress is generated at the central portion in the circumferential direction of the outer diameter wall surface 33 of the magnet insertion hole 30, excessive stress is generated on the first outer peripheral rib 21 and the second outer peripheral rib 22 of the rotor core 20 due to the moment of force.

In the embodiment, the outer diameter side space portion 43 is formed at the circumferential central portion in a portion between the outer diameter surface 63 of the permanent magnet 60 and the outer diameter wall surface 33 of the magnet insertion hole 30 and the circumferential central portion of the permanent magnet 60 does not abut on the magnet insertion hole 30. Therefore, excessive stress can be prevented from being generated on the outer peripheral surface 20a of the rotor core 20, particularly the first outer peripheral rib 21 and the second outer peripheral rib 22.

The foam sheet 90 is provided in the circumferential central portion of the permanent magnet 60. Therefore, when the foam sheet 90 is foamed, the outer diameter side first end portion 631 and the outer diameter side second end portion 632 of the permanent magnet 60 can abut on the outer diameter wall surface 33 of the magnet insertion hole 30 with an equal pressing force.

### Second Embodiment

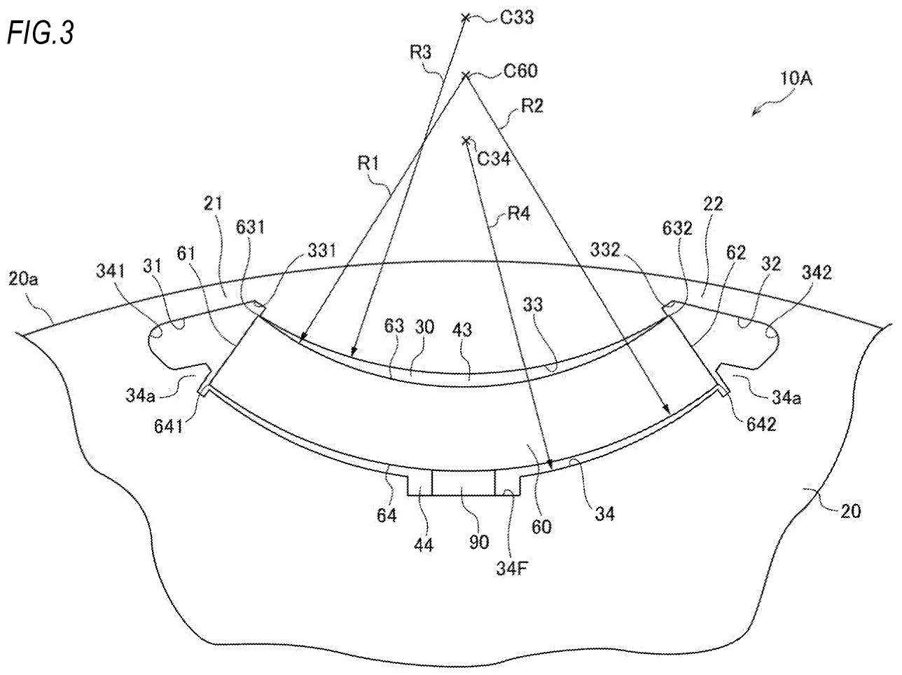

Subsequently, a rotor 10A according to a second embodiment of the invention will be described with reference to FIG. 3. In the following description, the similar components as those of the rotor 10 according to the first embodiment are denoted by the same reference numerals and the description thereof is omitted or simplified. Differences from the rotor 10 according to the first embodiment are described in detail.

As illustrated in FIG. 3, the inner diameter wall surface 34 of the magnet insertion hole 30 of the embodiment has a flat portion 34F which protrudes radially inward at the central portion in the circumferential direction. The foam sheet 90 is disposed between the inner diameter surface 64 at the central portion in the circumferential direction of the permanent magnet 60 and the flat portion 34F of the inner diameter wall surface 34 of the magnet insertion hole 30.

Since the flat portion 34F of the inner diameter wall surface 34 of the magnet insertion hole 30 is formed so as to protrude radially inward, the inner diameter side space portion 44 is surely formed between the inner diameter surface 64 of the permanent magnet 60 and the inner diameter wall surface 34 of the magnet insertion hole 30. Thereby, even when the arc radius R2 of the inner diameter surface 64 of the permanent magnet 60 and the arc radius R4 of the inner diameter wall surface 34 of the magnet insertion hole 30 are set to be close to each other, the inner diameter side space portion 44 is surely formed. As a result, insertability when the permanent magnet 60 is inserted into the magnet insertion hole 30 is excellent. By setting R2 and R4 to be close to each other, the magnet amount of the permanent magnet 60 and the iron amount of the rotor core 20 can be increased, and thus the output performance of the rotating electrical machine is improved.

The invention is not limited to the embodiments described above and modifications, improvements, and the likes can be made as appropriate.

For example, in the first embodiment and the second embodiment, one magnetic pole portion 50 is constituted by one permanent magnet 60. However, one magnetic pole portion 50 may be constituted by a plurality of permanent magnets. Here, each permanent magnet constituting the magnetic pole portion 50 and the magnet insertion hole into which the permanent magnet is inserted can have the same shape as in the present embodiment.

At least the following matters are described in the specification. Although the constituent component or the like which correspond in the embodiments described above are described in a parenthesis, it is not limited to this.

(1) A rotor (rotor 10) of a rotating electrical machine which includes:

a substantially annular rotor core (rotor core 20) with a plurality of magnet insertion holes (magnet insertion holes 30) formed along a circumferential direction; and

a plurality of magnetic pole portions (magnetic pole portions 50) including permanent magnets (permanent magnets 60) inserted into the plurality of magnet insertion holes, in which

the permanent magnet includes,
an outer diameter surface (outer diameter surface 63) having an arc shape which is convex radially inward, and
an inner diameter surface (inner diameter surface 64) having an arc shape convex radially inward and having the same arc center (arc center C60) as an arc center of the outer diameter surface,

the magnet insertion hole includes,

an outer diameter wall surface (outer diameter wall surface 33) facing the outer diameter surface of the permanent magnet, and

an inner diameter wall surface (inner diameter wall surface 34) facing the inner diameter surface of the permanent magnet,

an outer diameter side space portion (outer diameter side space portion 43) is formed at a circumferential central portion in a portion between the outer diameter surface of the permanent magnet and the outer diameter wall surface of the magnet insertion hole, and

an inner diameter side space portion (inner diameter side space portion 44) is formed at a circumferential central portion in a portion between the inner diameter surface of the permanent magnet and the inner diameter wall surface of the magnet insertion hole.

According to (1), since the permanent magnet has the outer diameter surface and the inner diameter surface which have arc shapes with the same arc center, the radial thickness is substantially the same in the circumferential direction. Thereby, since the thickness of both circumferential end portions of the permanent magnet which are easy to demagnetize becomes substantially the same as the thickness of the circumferential central portion, demagnetization can be prevented. Between the permanent magnet and the magnet insertion hole, the outer diameter side space portion and the inner diameter side space portion are formed at the central portion in the circumferential direction. Therefore, insertability when inserting the permanent magnet into the magnet insertion hole is excellent.

(2) In the rotor of the rotating electrical machine according to (1),

both the outer diameter wall surface and the inner diameter wall surface of the magnet insertion hole have an arc shape which is convex radially inward, and

R1<R3 and R2>R4 is satisfied when an arc radius of the outer diameter surface of the permanent magnet is set to R1, an arc radius of the inner diameter surface is set to R2, an arc radius of the outer diameter wall surface of the magnet insertion hole is set to R3, and an arc radius of the inner diameter wall surface is set to R4.

According to (2), since R1<R3 is satisfied, the outer diameter surface of the permanent magnet is not in contact with the outer diameter wall surface of the magnet insertion hole and the outer diameter side space portion can be reliably formed with a simple configuration. Since R2>R4 is satisfied, the inner diameter surface of the permanent magnet is not in contact with the inner diameter wall surface of the magnet insertion hole and the inner diameter side space portion can be reliably formed with a simple configuration.

(3) In the rotor of the rotating electrical machine according to (2),

the inner diameter wall surface of the magnet insertion hole has a flat portion (flat portion 34F) formed to protrude radially inward at the circumferential central portion.

According to (3), since the inner diameter wall surface of the magnet insertion hole has the flat portion formed to protrude radially inward at the central portion in the circumferential direction, the inner diameter side space portion can be reliably formed. Thereby, even when R2 and R4 are set to closer radii, insertability when inserting the permanent magnet into the magnet insertion hole is excellent.

(4) In the rotor of the rotating electrical machine according to any one of (1) to (3),

a foam sheet (foam sheet 90) is provided in the inner diameter side space portion.

According to (4), the foam sheet is provided in the inner diameter side space portion. Therefore, by inserting the permanent magnet into the magnet insertion hole and then foaming the foam sheet, the permanent magnet abuts on the outer diameter wall surface of the magnet insertion hole and is fixed. Here, the outer diameter side space portion is formed between the outer diameter surface of the permanent magnet and the outer diameter wall surface of the magnet insertion hole. Therefore, both circumferential end portions of the permanent magnet abut on the outer diameter wall surface of the magnet insertion hole and the circumferential central portion does not abut on the outer diameter wall surface of the magnet insertion hole. As a result, it is possible to prevent excessive centrifugal stress from being generated on the outer peripheral surface of the rotor core.

(5) In the rotor of the rotating electrical machine according to (4),

the foam sheet is provided at the circumferential central portion of the permanent magnet.

According to (5), the foam sheet is provided at the circumferential central portion of the permanent magnet. Therefore, when the foam sheet is foamed after inserting the permanent magnet into the magnet insertion hole, both circumferential end portions of the permanent magnet can abut on the outer diameter wall surface of the magnet insertion hole by uniform pressing force.

1. A rotor of a rotating electrical machine, comprising:
a substantially annular rotor core with a plurality of magnet insertion holes formed along a circumferential direction; and
a plurality of magnetic pole portions including permanent magnets inserted into the plurality of magnet insertion holes, wherein
the permanent magnet includes:
an outer diameter surface having an arc shape which is convex radially inward; and
an inner diameter surface having an arc shape convex radially inward and having the same arc center as an arc center of the outer diameter surface,
the magnet insertion hole includes:
an outer diameter wall surface facing the outer diameter surface of the permanent magnet; and
an inner diameter wall surface facing the inner diameter surface of the permanent magnet,
an outer diameter side space portion is formed at a circumferential central portion in a portion between the outer diameter surface of the permanent magnet and the outer diameter wall surface of the magnet insertion hole, and
an inner diameter side space portion is formed at a circumferential central portion in a portion between the inner diameter surface of the permanent magnet and the inner diameter wall surface of the magnet insertion hole.

2. The rotor of the rotating electrical machine according to claim 1, wherein
both the outer diameter wall surface and the inner diameter wall surface of the magnet insertion hole have an arc shape which is convex radially inward, and
R1<R3 and R2>R4 is satisfied when an arc radius of the outer diameter surface of the permanent magnet is set to R1, an arc radius of the inner diameter surface is set to R2, an arc radius of the outer diameter wall surface of the magnet insertion hole is set to R3, and an arc radius of the inner diameter wall surface is set to R4.

3. The rotor of the rotating electrical machine according to claim 2, wherein
the inner diameter wall surface of the magnet insertion hole has a flat portion formed to protrude radially inward at the circumferential central portion.

4. The rotor of the rotating electrical machine according to claim 1, wherein
a foam sheet is provided in the inner diameter side space portion.

5. The rotor of the rotating electrical machine according to claim 4, wherein
the foam sheet is provided at the circumferential central portion of the permanent magnet.
